(19) United States
(12) Patent Application Publication
(10) Pub. No.: US 2026/0022926 A1
(43) Pub. Date: Jan. 22, 2026

(54) MEASUREMENT ACCURACY PERCEPTION AND USER GUIDING FOR MANUALLY DRIVEN AACMM

(71) Applicant: HEXAGON TECHNOLOGY CENTER GMBH, Heerbrugg (CH)

(72) Inventors: Bernd REIMANN, Heerbrugg (CH); Jochen SCHEJA, Hohenems (AT); Laurent DESFORGES, Ambloy (FR)

(73) Assignee: HEXAGON TECHNOLOGY CENTER GMBH, Heerbrugg (CH)

(21) Appl. No.: 19/269,928

(22) Filed: Jul. 15, 2025

(30) Foreign Application Priority Data
Jul. 16, 2024 (EP) 24 188 984.9

(51) Int. Cl. G01B 5/012; G05B 13/02

(52) U.S. Cl. CPC G01B 5/012; G05B 13/0265

(57) ABSTRACT

An articulated coordinate measuring machine comprising a set of sensors, a probe for approaching an object point, and a set of members connecting the probe to a base. The probe is configured to be moved at least partially manually by an operator holding and guiding the probe and/or a handheld member of the set of members. The coordinate measuring machine comprises (i) an accuracy-assessment-functionality providing accuracy-perception-data based on continuously monitored actual data representing an actual state of said at least one state variable of the coordinate measuring machine during the guiding of the probe, and (ii) a user-support-functionality providing a support action during the guiding of the probe based on the accuracy-perception-data.

### FIELD

The disclosure relates to an operator action sensor for a substantially manually driven articulated arm coordinate measuring machine (AACMM), the CMM with the operator action sensor and the operation of said CMM. The CMM comprises a probe for approaching an object point, and a set of members connecting the probe to a base. The probe is moved at least partially manually by an operator exerting a force or torque on a hand-controlled member of the set of members.

### BACKGROUND

A CMM is a machine configured to measure 3D coordinates of certain points, in particular the whole surface topography, of a workpiece. CMMs are important in various industries, e.g., production measurement, quality control, or reverse engineering. They are utilized, e.g., to determine deviations of the geometry of manufactured products from design models, in particular to determine whether the deviations are within the manufacturing tolerance. Another application of a CMM gaining more prominence is the reverse engineering of an object, where no design model exists, but an operator provides a guidance of the probe.

Portable measurement arms offer a flexible, time and cost-efficient solution for such measurement tasks. Portable measurement arms comprise a base connecting the machine to a typically inert support structure, a set of articulated elements, a set of internal sensors providing data regarding the state of said elements, a probe interface configured to accommodate a probe, typically in an exchangeable manner, and one or more probe. The probe is configured to interact with the workpiece in tactile and/or in non-contact manner and (relative) coordinate data regarding an object point on the workpiece is derived based on the state of the articulated elements and a data provided by the probe.

Many designs are at least theoretically feasible for the types and arrangement of the articulated elements of portable measurement arms. However, practical considerations, e.g., the need for ultra-high accuracy, low weight, large accessible volume, lead to a preferred embodiment, in which the arm comprises a series of hinges and elongated cylindrical segments with parts allowing rotation about their axes. Most of the above-mentioned elements are non-motorized, i.e., the probe head is manually guided and a decisive part of the driving force for the movement of the articulated elements is provided by the muscle power of the operator.

Segments provide at least partial rotatability about an axis substantially parallel to a longitudinal axis of the segments, in particular a distal portion of the segments might be rotatable with respect to a proximal portion. The segments thus comprise a metrological link—e.g., a substantially rigid member—and a metrological joint. Hinges provide at least partial rotatability about an axis which is angled with respect to the axes of the connected segments, in particular perpendicular thereto. Contemporary AACMMs use one degree of freedom articulated elements, due to improved pose reproducibility and measurement accuracy. Nonetheless, the respective one-dimensional joints are often placed in the proximity of each other creating an effectively multi-dimensional transfer element.

To achieve a large accessible volume and/or to provide alternative measurement path AACMMs are typically underdetermined as mechanical systems. I.e., the same probe posture can be realized by many different postures of the articulated elements. Nevertheless, the measurement accuracy of the AACMM show large differences in the different postures. For example, it is preferable that the encoders are aligned parallel to or orthogonal to the direction of gravity.

Due to the comparably lower costs and the purported case of use such portable measurement arms are often used in factory floor environments. Moreover, the operators often lack well-founded metrology knowledge and/or extended training regarding the proper usage of the portable measurement arm. Wrong handling of the arm can massively reduce the measurement performance of an articulated arm. Inaccuracy may arise from improper pose of the articulations, e.g., wherein external forces or the operator's body heat might temporarily or permanently deform the arm, which leads to measurement errors. Inaccuracy may also arise from improper handling of the pose changes. I.e., to reach an optimal relative accuracy between measurement points the axis motion should be as small as possible. With large encoder displacement axis inaccuracies have a negative impact on the measurement accuracy.

Another important aspect, especially when measuring large objects or objects with difficult-to-access interior spaces, is that the quality of the overall measurement data can be compromised by one or more inaccurately measured object points. In the prior art system such compromised object points are only uncovered during the post-processing of the data, when the compromised data cannot be easily re-acquired.

### SUMMARY

In view of the above circumstances, one object of the present disclosure is to improve the handling of manually guided AACMMs.

A second objective of the present disclosure is to shorten the training required to achieve the required skills for the operator of AACMMs.

A third objective of the present disclosure is to provide a near real-time assessment and feedback regarding the measurement accuracy of coordinate acquisition.

The disclosure relates to a CMM, more particularly a substantially manually driven, AACMM. Substantially manually driven means that the operator of the AACMM touches one or more components of the measuring arm and guides the probe thereby.

The AACMM comprises a set of sensors, a probe for approaching an object point, a set of members connecting the probe to a base. The members comprise links and joints. One of the members might be embodied as or might comprise a probe interface configured to accommodate a probe in an exchangeable manner.

The probe is configured to be moved at least partially manually by an operator holding and guiding the probe and/or a handheld member of the set of members. The probe is configured to measure probing data corresponding to an interaction between the probe and the object point. The probe might be a tactile probe configured to provide probing data by mechanically interacting with the object point. However, the disclosure is equally applicable to AACMMs equipped with non-contact probes such as triangulation sensors, laser scanners or ultrasound probes. The probe, probe interface, or the handheld member might comprise an operator interaction element configured (a) to provide a better grip for the operator and/or (b) to enable an activation of direct operator commands. At least one sensor in the set of sensors might be associated with at least one of the articulated elements and configured to provide sensor data regarding the at least one associated element. In particular, at least the rotation state of each of the articulated elements is tracked by the appropriate sensors. One or more articulated elements might be associated with a plurality of sensors.

At least one sensor in the set of sensors, in particular the displacement and/or force measuring sensors, might provide sensor data regarding a plurality of the articulated elements.

Sensor might be realized as a distributed sensor comprising a plurality of physically distinct sensor components and the sensor data are provided by the assembly as a whole.

The CMM is configured to derive a pose of the probe based on sensor data provided by the set of sensors and to provide coordinate data of the object point based on the probing data and the pose of the probe. Coordinate data might be relative coordinates to further object points in the environment.

The CMM is further configured (i) to obtain target data representing a target state of at least one state variable of the CMM, (ii) to derive actual data representing an actual state of said at least one state variable based on sensor data provided by the set of sensors, and (iii) to continuously monitor the actual data.

The CMM further comprises an accuracy-assessment-functionality. The accuracy-assessment-functionality is configured to provide accuracy-perception-data based on the continuously monitored actual data and the target data during the guiding of the probe and/or the handheld member. The accuracy-assessment functionality might provide the accuracy-perception data in the form of numerical values, particularly as confidence value or confidence range regarding the pose of a component of the AACMM. Said component might be the probe. By way of example such data can be useful for experienced operator when deciding whether to re-acquire the previously performed measurement.

The accuracy-assessment-functionality might provide the accuracy-perception-data as an assessment regarding the “proper usage”. Particularly the accuracy-assessment-functionality might compare a modelled accuracy of the actual posture of the CMM with the modelled accuracy of an alternative posture realizing the same probe pose. In particular, the accuracy-perception-data can be generated as compliance with a tolerance band for accuracy. By way of example such data might be useful during the training of operators.

The CMM further comprises a user-support-functionality being configured to provide a support action during the guiding of the probe and/or the handheld member based on the accuracy-perception-data. Preferably the user-support-functionality provides the support action in near real time.

In some embodiments, the CMM further comprises an accuracy-optimization-functionality. The accuracy-optimization-functionality is configured (i) to access a training database comprising training data regarding a plurality of recorded pose uncertainties associated with corresponding recorded states of at least one state variable, (ii) to derive a model pose uncertainty associated with at least one nonrecorded state of the at least one state variable, and (iii) to derive the target data based on the training database. The derived target data are associated with one recorded pose uncertainty or one model pose uncertainty below an uncertainty threshold. The accuracy-optimization-functionality is configured (i) to derive at least one model pose uncertainty associated with at least one nonrecorded state of the set of state variables, (ii) to derive a target state of the plurality of state variables based on the training database. It is self-explanatory that numerals and letters, like above, do not represent e.g., a sequence of performing the steps, not even in the form of a preferred sequence, or any spatial, temporal, or causal connections and merely serve the purpose of readability. Unless expressly provided for reasonable variations of steps of method and/or spatial arrangement of device components are within the scope of the disclosure.

In some specific embodiments, the training database comprises training data regarding a plurality of recorded pose uncertainties associated with corresponding recorded states of sets of state variables, the set of state variables comprising a plurality of state variables. In other words, the CMM is configured to provide an accuracy space, particularly a multivariable space, and derive at least one point, particularly a domain comprising a plurality of points, as a target within said space. By way of example such multivariable space might relate to the attitude of the articulated members.

In some cases, specific poses or pose-areas can be pre-defined as less accurate or un-desired. In some specific embodiments, the CMM comprises a neural network and/or is configured to establish an operative coupling with a neural network. The neural network is configured to execute the computational steps of the accuracy-assessment-functionality and/or the accuracy-optimization-functionality. Undesired poses or pose-areas might be provided to the neural network as input data or used separately, e.g. as hardcoded un-desired poses or pose-areas.

In some embodiments, the CMM comprises an operator action sensor. The operator action sensor is configured to provide data regarding a force and/or a torque exerted by the operator on the probe and/or the handheld member. The target data comprise data corresponding to a force and/or torque threshold. The actual data comprise data corresponding to the measured force and/or torque exerted by the operator. The support action might comprise a warning of excessive force and/or torque exerted by the operator. Such operator action sensors might be mounted on the probe, the probe interface or on the handheld member. The operator action sensor or a further sensor might comprise accelerometers providing sensor data regarding a dynamic behavior of the CMM.

In some specific embodiments, the operator action sensor comprises a grip surface configured to be held by the operator during the guiding of the probe and/or the handheld member. The target data comprise data corresponding (i) to a grip threshold and (ii) to a rate of change threshold, in particular wherein the rate of change threshold corresponds to a linear or angular velocity of the probe. The actual data comprise data corresponding to (i) the measured force and/or torque exerted by the operator, and (ii) the measured rate of change of the pose of the probe. The support action might comprise a suggestion for an amended grip by the operator. In other words, the CMM monitors whether the operator guides the probe via the grip surface configured for this purpose. In the case when the probe moves despite a lack of force at the grip surface the CMM could provide feedback.

In some embodiments, the CMM is configured to derive an orientation of at least one link from the set of members based on sensor data provided by the set of sensors. The target data comprise data corresponding to a target orientation or orientation domain of said link. The actual data comprise data corresponding to a measured orientation of said link. The support action might comprise a warning of non-optimal orientation of the link. It is known that for many sensor optimal accuracy is achieved if the sensor has a specific orientation with respect to the gravity vector. A direction of gravity can be determined independently at each metrology joints. Alternatively or additionally to the feedback, commands might be provided to the motorized joints to approach the target attitude.

In some specific embodiments, the CMM is further configured (i) to obtain workpiece model data, (ii) to perform a matching of measured coordinate data of a set of object points with the workpiece model data, (iii) to provide an assessment regarding a predicted object point based on said matching, particularly on the base of measurement sequences stored in the database or a measurement sequence derived on the basis of a training database, and (iv) to provide a predicted pose of at least one monitored member from the set of member based on the predicted object point. The target data comprise data corresponding to a target path towards the predicted pose of the monitored member. The actual data comprise data corresponding to a measured or modelled actual pose of the monitored member.

In some specific embodiments, the target data are provided by the accuracy-optimization-functionality. Alternatively or additionally, the support action comprises (i) an orientation aid to guide the probe and/or the handheld member of the set of members to realize target path towards the predicted pose of the monitored member, particularly a motorized orientation aid performed automatically, and/or (ii) a workpiece placement aid comprising a suggested placement of the workpiece relative to the coordinate measuring machine, and/or (iii) workpiece identification and an object point aid based on the detected workpiece comprising a suggested object point on the workpiece, in particular wherein the suggested object point corresponds to a stored object point from a stored measurement and/or a derived object point derived on the basis of the training database.

In some specific embodiments, the CMM comprises an internal perception sensor. The internal perception sensor is arranged or integrated to the CMM. The internal perception sensor is configured to provide spatial arrangement data regarding an environment of the CMM. By way of example, the CMM might be configured to obtain the workpiece model data based on the spatial arrangement data.

In some specific embodiments, the CMM is configured to access data from an external perception sensor external to the CMM. The external perception sensor is configured to provide spatial arrangement data regarding an environment of the CMM. The external and internal perception sensors might be used in combination. The CMM is also configured to obtain the workpiece model data based on the spatial arrangement data. Workpiece data comprises partial data, particularly data required for workpiece identification. A non-exclusive list of such data might be a specific face, particularly the front, an unambiguous area, a serial number, or QR code.

In some specific embodiments, the CMM comprises a crash-protection functionality. The crash-protection functionality is configured to provide an assessment regarding a collision of at least one member with an object in the environment based on the spatial arrangement data and the predicted pose of the at least one member. The CMM comprises a brake configured to hinder, or to lock, the movement of at least one braked member based on the assessment regarding a collision of at least one member.

In some embodiments, the CMM comprises at least one motorized member and a servo-functionality. The motorized member is configured to provide a servo-torque. The servo-functionality is configured to set the servo-torque with respect of the actual and predicted pose of the monitored member.

In some embodiments, the set of sensors comprises a temperature sensor. The at least one state variable is a temperature of at least one member and/or a temperature of the probe. The support action comprises a suggestion for an amended grip by the operator. Particularly, via a temperature sensor the CMM can provide an assessment regarding a false grip of the operator, wherein the body heat of the operator might cause a temperature above the accuracy threshold of one of the sensors. Alternatively or additionally, the detected heat might be an indicator of further influencing factors, e.g., a possible bending of one of the links.

In some embodiments, the CMM is configured to access an operator database. The operator database comprises an operator identifier and data regarding a history of operator behavior. The CMM is configured to associate a current operator with one of the operator identifiers, in particular automatically based on a comparison of current operator behavior with the history of operator behavior. The accuracy-perception-data are provided further based on current operator behavior and of the history of operator behavior. By way of example, the typical measurement gestures/patterns might be different for taller operator than a shorter one and the support action can be provided with respect of the preferred measurement gestures/patterns.

In some specific embodiments, the CMM is configured (i) to record the current operator behavior, and (ii) to adapt the history of operator behavior based on the recorded current operator behavior. The CMM might provide an assessment regarding an evolution of the operator behavior, particularly for training purposes for the operator.

### BRIEF DESCRIPTION OF THE DRAWINGS

By way of example only, specific embodiments will be described more fully hereinafter with reference to the accompanying figures, wherein:

FIG. 1a shows a generic AACMM.

FIGS. 1b and 1c show measurements wherein an operator guides the probe and a handheld member.

FIG. 2 depicts, by a flowchart, a method for determining of coordinate data.

FIG. 3 depicts, by a high-level flowchart, key elements of the inventive control algorithm.

FIG. 4 schematically depicts a derivation of target data based on a training database.

FIGS. 5a and 5b depict an exemplary embodiment of an operator action sensor.

FIG. 6 depicts an embodiment of the inventive control algorithm, wherein the proper grip is verified.

FIG. 7 depicts, by a flowchart, an embodiment, wherein the measured coordinate data are matched with a workpiece model data from a database.

FIG. 8 schematically depicts the provision of spatial arrangement data by internal and external perception sensors.

FIG. 9 schematically depicts the management of an operator database.

### DETAILED DESCRIPTION

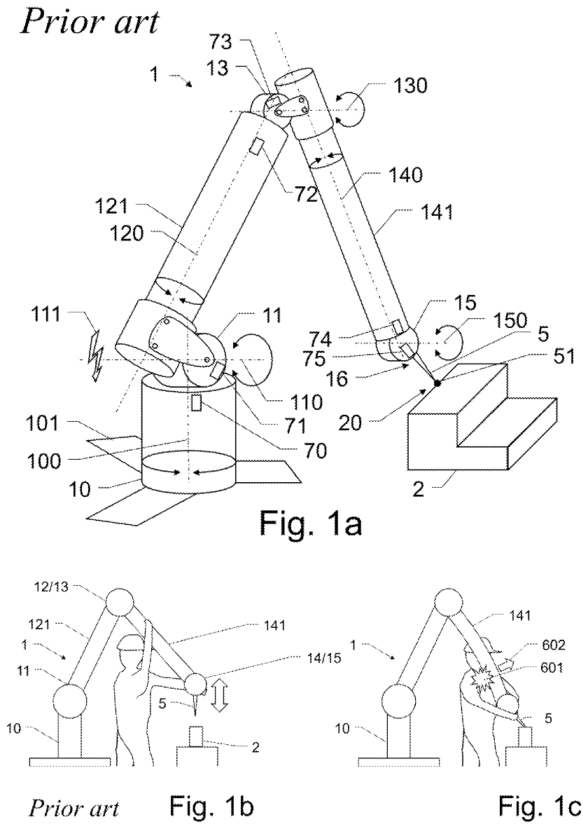

FIG. 1a shows a generic AACMM 1 performing a coordinate measurement on a workpiece 2. The depicted AACMM is equipped with a tactile sensor as the probe 5 mounted on the probe interface 16. I.e., the operator performs the coordinate measurement by touching an object point 20 with a tactile sensing element 51, depicted as ruby sphere. The AACMM 1 comprises a base 10 with fixing elements 101, e.g., permanent magnets, screws, pneumatic components etc., configured to provide a mechanical coupling with the environment in a fixed pose relative to the workpiece. The AACMM 1 also comprises a set of articulated members 11,13,15,121,141 connecting the probe 5 to the base 10. The articulated members 11,13,15,121,141 comprise links 121,141 and joints 11,13,15.

In the depicted embodiment each of the joints 11,13,15 and the base 10 provides a rotational degree of freedom about respective axes 100,110,120,130,140,150. The links 121,141 are clongated cylinders and the axes of rotation 120,140 of the segment joints (not shown) correspond to the direction of elongation. The further joints 11,13,15 are depicted as hinges providing a rotation about an axis perpendicular to the axes 100,120,140 of the base 10 and/or of the links 121,141. The side of the joints 11,13,15 kinematically closer to the base 10 has a fixed spatial relationship with the respective proximal component. The AACMM 1 comprises a set of internal sensors 70-75. Each sensor is associated with at least one of the members 11,13,15,121,141 and provides actual joint and/or actual link data. In the depicted embodiment the first joint 11 is motorized 111, i.e., the AACMM 1 is configured to provide a servo-torque for the first joint 11 in response of operator actions. While many features are illustrated with embodiments like the one depicted in FIG. 1a, the disclosure is not limited to this embodiment.

FIG. 1b-1c depicts a measurement routine, where coordinates of a workpiece 2 are determined by an AACMM 1 having a probe 5 with a tactile sensing element. The depicted AACMM comprises a set of members 11-15,121,141 connecting the probe 5 to a base 10. For simplicity the depicted links 121,141 are considered as essentially rigid members, while some of the depicted joints 11-15 are considered to provide mobility of more than one degree of freedom. To ensure the highest possible accuracy, the attitude of the members 11-15,121,141 and the probe 5 should be consistent throughout the measurement. This can be achieved using the depicted method, wherein the members 11-15,121,141 and the probe 5 are constrained to a vertical plane, by the operator holding the second link 141, or alternatively the probe 5 vertically. For this, however, the operator either must grip the second link 141 far from the probe, as depicted, or must exert excessive torque. Both are tiresome; thus the operator is tempted to support the handheld member 141 on the shoulder. This however could result in a deformation of the second link 141 by bending 602 or through body heat 601 causing a temporary or permanent loss of accuracy for the AACMM 1.

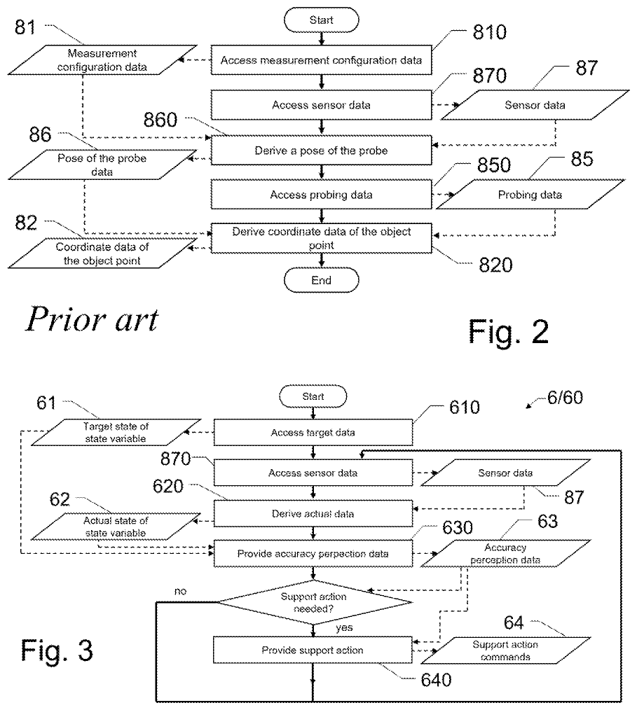

FIG. 2 illustrates a generic method of deriving 820 coordinate data 82 of the object point by a flowchart. Command/flow-lines shown as bold and data-lines as dashed arrows. The skilled person understands that the depicted flowcharts focus on the essential features and the actual embodiments comprise further, non-depicted elements, in particular command or data elements and/or data transfer lines. Moreover, command or data modules might be depicted in a simplified form due to reasons of clarity and conciseness. Unless where otherwise provided, or where a distinction provides a notable effect the data elements and the related real-world objects are labelled with the same reference signs.

In a first step measurement configuration data 81 representing the geometry, in particular the metrology chain, of the CMM and sensor data 87 is accessed 810/870. The sensor data 87 is representative of at least a relative motion, preferably a relative pose, provided by the articulated elements. Based on the measurement configuration data 81 and the sensor data 87 a pose of the probe 86, preferably an absolute pose of the probe, is derived 860. In a next step the probing data 85 is also accessed 850. The probing data 85 might comprise interaction information between the probe and the object point, e.g., a distance of the two. Based on the pose of the probe 86 and the probing data 85 coordinate data 82 of the object point is derived 820. There are many variations and alternatives of the here depicted method in the state of the art and the disclosure is not limited to any specific embodiment.

As can be seen the pose of the probe 86 is determined based on a metrology chain comprising a plurality of sensors and/or non-measured nominal data, e.g., a length of a link. Inaccurate sensor data 87 thus propagates through the chain leading to inaccurate coordinate 82 measurements. Such inaccuracy might arise due to inherent sensor inaccuracy e.g., due to sub-optimal attitude of the sensor and/or dynamic effects. Inaccuracy can also arise due to unknown factors such as non-measured bending of the links.

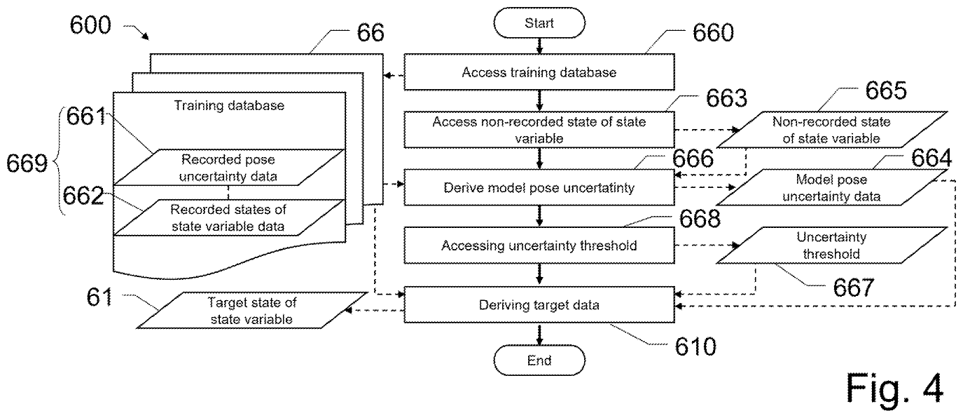

FIG. 3 depicts, by a high-level flowchart, the concepts of the inventive accuracy-assessment-functionality 6 and user-support-functionality 60. Some aspects will be discussed in more detail in the further figures. In a first step target data 61 representing a target state of at least one state variable of the coordinate measuring machine are obtained 610. By way of example, state variables can be the attitudes, (linear) velocities, angular velocities, respective accelerations of one or more articulated members or the probe, respective thermodynamic or operational data, particularly data relating to a malfunction, of one or more components, component identification data. State variables can also represent environment data, particularly the pose of one or more components with respect to objects in the environment, in particular the workpiece. State variable can also represent operator related data, such as operator identification data or forces and torques exerted by the operator on one or more of the components. The above list is non-exhaustive. In typical cases the target data 61 comprise data relating to target states of a plurality of state variables. For reasons of brevity and transparency many of the depicted examples will disclose cases with target data relating to a single state variable. The features of the embodiments with a plurality of state variables can be applied accordingly.

In the following steps sensor data 87 are accessed 870 and actual data 62 relating to the actual state of the state variable are derived 620. The accuracy perception data 63 are provided 630 based on the actual data 62 and the target data 61. Based on the accuracy perception data 63, alternatively or additionally on the target 61 and actual data 62, it is inspected whether a support action 64 is required. If needed a support action 64 is provided 640. Support actions 64 might be alerts/warnings provided, particularly displayed, to the operator. Support actions 64 might also represent active measures, such as adjusting a joint. The depicted algorithm is running continuously. While not shown, it is evident that the target data 61 might be re-accessed 610 in certain steps.

By way of example the target state of the state variable might represent a state of the CMM with sufficient measurement accuracy, i.e., when the actual state of the state variable corresponds to the target state the accuracy perception data might be a flag with a “true” value, thus no support action 64 is needed. Further cases will be discussed in the following figures.

FIG. 4 depicts, by a flowchart, an embodiment of the accuracy-optimization-functionality 600 deriving 610 the target data 61 based on a training database 66. In a first step a training database 66 is accessed 660. The training database 66 comprises training data 669 regarding a plurality of recorded pose uncertainties 661 associated with corresponding recorded states 662 of one or more state variables. In a next step a non-recorded state 665 of the one or more state variables is accessed 663. A corresponding model pose uncertainty 664 associated the nonrecorded state 665 of the one or more state variables is derived 666 based on the training database 66. In a following step an uncertainty threshold 667 is accessed 668. The target data 61 is derived 610 based on the training database 66, such that target data 61 is associated with one recorded pose uncertainty 661 or one model pose uncertainty 664 below an uncertainty threshold 667. The target data 61 might also represent a plurality or a continuum of states of the state variables associated with pose uncertainties below the threshold 667.

By way of example, the training database 66 might be created to contain recorded states 662 with only the lowest pose uncertainties, however with sub-optimal reach. For a measurement of large object with less stringent accuracy requirements a new domain of allowed states comprising previously non-recorded states 665, wherein the associated model pose uncertainty 664 fulfils the less stringent threshold 667 might thus be derived from the existing training database 66. This allows the possibly inexperienced operator to carry out the measuring task without relying on own intuition.

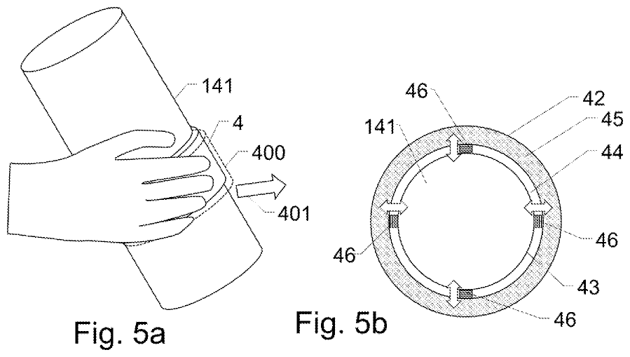

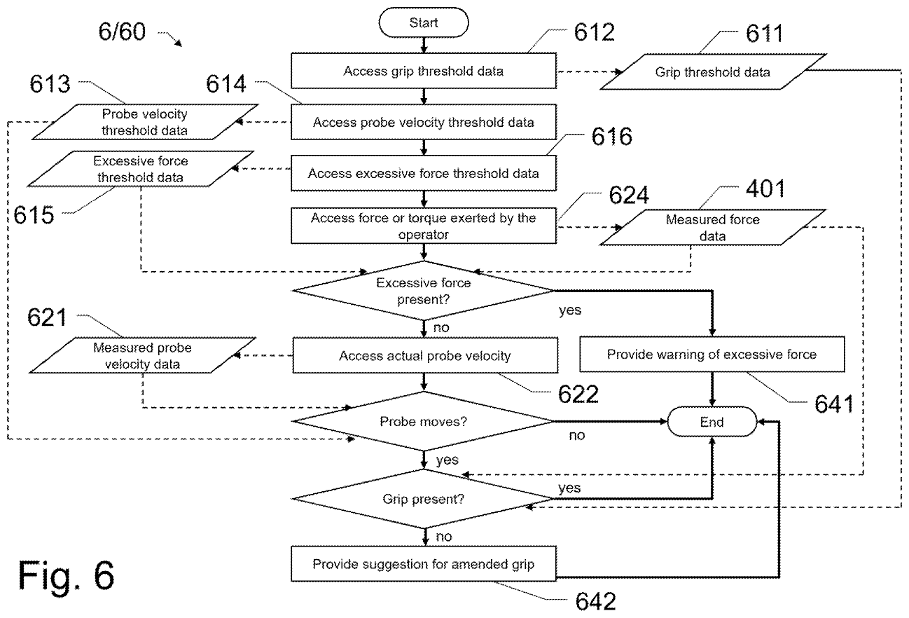

FIG. 5a depicts an embodiment of an operator action sensor 4 as a touch sensitive band mounted to the hand-controlled member 141. The depicted the hand-controlled member 141 is the second link, which is kinematically close to the probe. The depicted operator action sensor 4 is mounted such that it is concentric to the handheld member 141 in a rest state and elastically displaceable to a displaced state. The measured displacement 400 comprises information regarding a force 401 or torque exerted by the operator.

FIG. 5b depicts a cross-sectional view of the operator action sensor. The operator action sensor comprises a grip surface 42 configured to be held by the operator guiding the handheld member 141. The operator action sensor also comprises an inner surface 43 configured to interact with the handheld member 141, an internal volume 44 comprising a sensing element 46. The sensing element 46 is configured to provide data regarding the force or torque exerted by the operator. The depicted operator action sensor further comprises a thermal isolation region 45 configured to provide a thermal isolation between the inner 43 and the outer surfaces 42. Alternatively or additionally, the operator action sensor might be configured such that it provides force measurement axial to the link acting as the handheld member 141.

FIG. 6 depicts an embodiment of the inventive accuracy-assessment-functionality 6 and user-support-functionality 60. In the depicted embodiment the proper grip is verified, in particular, whether the operator is holding the probe and/or the hand-held element using the intended gripping surface and whether the applied force or torque corresponds to proper actuation. Preferably a correction is derived and applied based on the applied force or torque and an existing compensation model or training data. The applied correction at least partially compensates the deformation and/or the effects arising from the deformation. Alternatively or additionally, a user warning will be provided, e.g. when the applied force is too high.

The functionality 6/60 accesses 612,616 a first force threshold 611 corresponding to a minimal force associated with a proper grip and second force threshold 615 corresponding to an excessive force applied to guide the probe. A movement threshold 613 corresponding to a definite movement of the probe is also accessed 614. Then the force 401 or torque applied by operator is measured 624, particularly via an operator action sensor, e.g., similarly to the embodiment depicted in FIG. 5. A measured or modelled velocity 621 of the probe is also provided 622. The skilled person knows many possibilities to determine said velocity. A non-exhaustive list comprises the use of the sensors of the metrology chain, internal inertial sensors, tracking of the probe by external sensors, tracking the environment by a sensor moving with the probe. The present disclosure is applicable in principle with any of the listed options, suitable alternatives or combinations thereof.

The depicted embodiment foresees two support actions. If measured forces 401 or torques above the excessive force threshold 615 are detected an excessive force warning 641 is provided. If a definitive movement of the probe is determined without the presence of a corresponding grip force suggestions for an amended grip 642 are provided. The depicted functionality can also be performed in a loop.

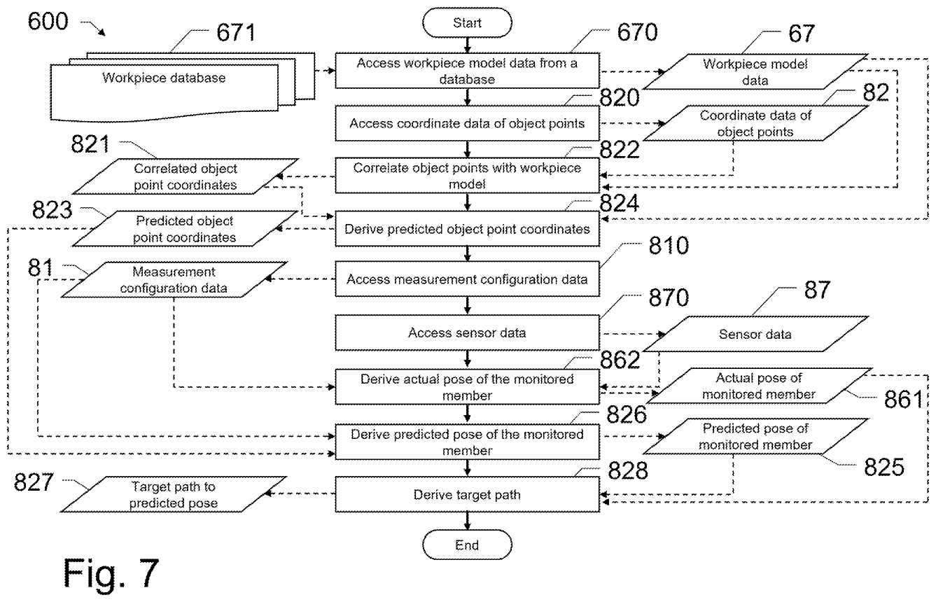

FIG. 7 depicts another embodiment of the accuracy-optimization-functionality 600, wherein a target path 827 of a monitored component from an actual pose 861 to a predicted pose 825 is provided 828. The actual pose is provided 862 based on accessed 810/870 measurement configuration 81 and sensor data 87 in a manner depicted in FIG. 2. The predicted pose 825 is provided 826 based on matching 822 a workpiece model 67 from a database 671 with measured 820 coordinates 82 of object points. Based on the matched coordinates 821, as well as the workpiece model data 67, particularly typical measurement sequences used to obtain the still missing coordinates, predicted object point coordinates 823 are provided 824. The predicted pose 825 of the monitored member is provided based on the measurement configuration data 81 and the predicted object point coordinates 823. While not explicitly shown on the illustration it is clear that both the predicted pose 825 of the monitored member as well as the target path 827 corresponds to states which fulfill the measurement accuracy requirements.

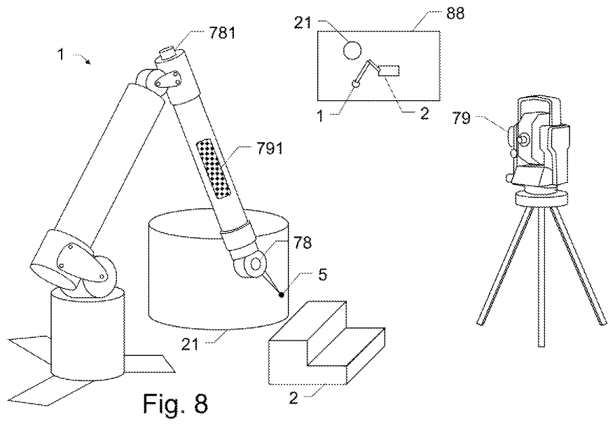

FIG. 8 depict the CMM 1 in an environment comprising the workpiece 2 and a further object 21. The depicted CMM comprises an internal perception sensor 78,781 arranged or integrated to the CMM 1. By way of example one of the sensors is a proximity sensor 78 e.g., a lidar or an ultrasonic sensor or a range-imaging camera, arranged near the probe 5. Alternatively, the proximity sensor 78 might be arranged in the rotating part of the base and rotates with the base such that the probe 5 is in the field of view of the proximity sensor 78. The other internal perception sensor 781 is a high field of view camera arranged at one of the joints. The internal perception sensors 78,781 are configured to provide spatial arrangement data 88—shown as an insert—regarding the objects 2,21 in environment of the CMM 1. While not shown, the depicted CMM 1 might be configured to obtain the workpiece model data regarding the workpiece 2 based on said spatial arrangement data 88.

Alternatively or additionally, the CMM 1 might be configured to access data from an external perception sensor 79, depicted as a laser tracker, external to the CMM 1. The external perception sensor 79 is configured to provide spatial arrangement data 88 regarding the objects 2,21 in environment and the CMM 1. The depicted CMM 1 comprises a tracking area 791 configured to aid the tracking of the CMM 1. Alternative tracking methods, in particular camera-based methods are also possible.

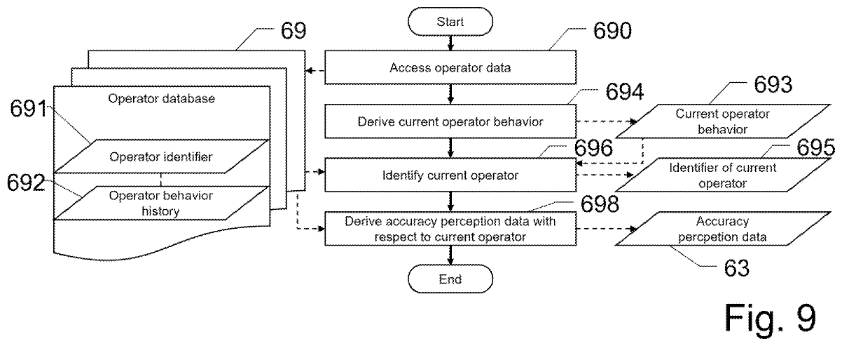

FIG. 9 depicts the performance of the measurement task based on an operator database 69 comprising an operator identifier 691 and associated data regarding a history of operator behavior 692. In a first step the operator database 69 is accessed 690. Then the current operator behavior 693 is derived 694. This can be realized by analyzing the typical measurement poses or measurement gestures performed by the operator. By way of example, typical measurement gestures/patterns might be different for taller operator than a shorter one. A more experienced operator might provide more delicate gestures and guide the probe with less force and generally more effectively. The grip of some operators might be firmer, especially during the performance of specific measurement gestures. By comparing the current operator behavior 693 with the history of operator behavior 692 the current operator 695 is identified 696. Alternatively, the identifier of the current operator 695 might be provided manually. The accuracy-perception-data 63 is provided 698 further based on current operator behavior 693 and of the history of operator behavior 692. Additionally or alternatively, the support-action is also provided with respect to the current operator behavior 693 and of the history of operator behavior 692. In other words, the support-action can be provided with respect of the preferred measurement gestures/patterns.

It is clear to the skilled person that the depicted embodiments of the accuracy-optimization-functionality and/or the user-support-functionality focuses on specific aspects and can be combined with each other and/or with other functionalities of the control software and hardware of the CMM.

Although aspects are illustrated above, partly with reference to some specific embodiments, it must be understood that numerous modifications and combinations of different features of the embodiments can be made. All of these modifications lie within the scope of the appended claims.

1. An articulated arm coordinate measuring machine comprising a set of sensors, a probe for approaching an object point, and a set of members connecting the probe to a base, the members comprising links and joints, wherein:
the probe is configured:
to be moved at least partially manually by an operator holding and guiding the probe and/or a handheld member of the set of members, and
to measure probing data corresponding to an interaction between the probe and the object point,
the coordinate measuring machine is configured:
to derive a pose of the probe based on sensor data provided by the set of sensors, and
to provide coordinate data of the object point based on the probing data and the pose of the probe,
the coordinate measuring machine is configured:
to obtain target data representing a target state of at least one state variable of the coordinate measuring machine,
to derive actual data representing an actual state of said at least one state variable based on the sensor data, and
to continuously monitor the actual data,
the coordinate measuring machine comprises:
an accuracy-assessment-functionality being configured to provide accuracy-perception-data based on the continuously monitored actual data and the target data during the guiding of the probe and/or the handheld member, and
a user-support-functionality being configured to provide a support action during the guiding of the probe and/or the handheld member based on the accuracy-perception-data.

2. The coordinate measuring machine according to claim 1, further comprising an accuracy-optimization-functionality being configured:
to access a training database comprising training data regarding a plurality of recorded pose uncertainties associated with corresponding recorded states of at least one state variable,
to derive a model pose uncertainty associated with at least one nonrecorded state of the at least one state variable, and
to derive the target data based on the training database, wherein the derived target data is associated with one recorded pose uncertainty or one model pose uncertainty below an uncertainty threshold.

3. The coordinate measuring machine according to claim 2, wherein:
the training database comprises training data regarding a plurality of recorded pose uncertainties associated with corresponding recorded states of sets of state variables,
the set of state variables comprising a plurality of state variables,
the accuracy-optimization-functionality is configured:
to derive at least one model pose uncertainty associated with at least one nonrecorded state of the set of state variables,
to derive a target state of the plurality of state variables based on the training database.

4. The coordinate measuring machine according to claim 2, comprising a neural network and/or being configured to establish an operative coupling with a neural network, the neural network being configured to execute the computational steps of the accuracy-assessment-functionality and/or the accuracy-optimization-functionality.

5. The coordinate measuring machine according to claim 1, wherein:
the coordinate measuring machine comprises an operator action sensor configured to provide data regarding a force and/or a torque exerted by the operator on the probe and/or the handheld member,
the target data comprise data corresponding to a force and/or torque threshold, and
the actual data comprise data corresponding to the measured force and/or torque exerted by the operator,
wherein the support action comprises a warning of excessive force and/or torque exerted by the operator.

6. The coordinate measuring machine according to claim 5, wherein:
the operator action sensor comprises a grip surface configured to be held by the operator during the guiding of the probe and/or the handheld member,
the target data comprise data corresponding to:
a grip threshold, and
a rate of change threshold, wherein the rate of change threshold corresponds to a linear or angular velocity of the probe,
the actual data comprise data corresponding to:
the measured force and/or torque exerted by the operator, and
the measured rate of change of the pose of the probe,
wherein the support action comprises a suggestion for an amended grip by the operator.

7. The coordinate measuring machine according to claim 1, wherein:
the coordinate measuring machine is configured to derive an orientation of at least one link from the set of members based on the sensor data,
the target data comprises data corresponding to a target orientation or orientation domain of said link,
the actual data comprises data corresponding to a measured orientation of said link,
wherein the support action comprises a warning of non-optimal orientation of the link.

8. The coordinate measuring machine according to claim 7, being further configured:
to obtain workpiece model data,
to perform a matching of measured coordinate data of a set of object points with the workpiece model data,
to provide an assessment regarding a predicted object point based on said matching,
to provide a predicted pose of at least one monitored member from the set of members based on the predicted object point,
wherein:
the target data comprises data corresponding to a target path towards the predicted pose of the monitored member,
the actual data comprises data corresponding to a measured or modelled actual pose of the monitored member,
the target data is provided by the accuracy-optimization-functionality, and/or
the support action comprises:
an orientation aid to guide the probe and/or the handheld member of the set of members to realize target path towards the predicted pose of the monitored member, and/or
a workpiece placement aid comprising a suggested placement of the workpiece relative to the coordinate measuring machine, and/or
a workpiece identification and an object point aid based on the detected workpiece comprising a suggested object point on the workpiece, in particular wherein the suggested object point corresponds to a stored object point from a stored measurement.

9. The coordinate measuring machine according to claim 8, wherein:
the coordinate measuring machine comprises an internal perception sensor arranged or integrated to the coordinate measuring machine,
the internal perception sensor is configured to provide spatial arrangement data regarding an environment of the coordinate measuring machine,
wherein the coordinate measuring machine is configured to obtain the workpiece model data based on the spatial arrangement data.

10. The coordinate measuring machine according to claim 8, being configured:
to access data from an external perception sensor external to the coordinate measuring machine, the external perception sensor being configured to provide spatial arrangement data regarding the environment of the coordinate measuring machine, and to obtain the workpiece model data based on the spatial arrangement data.

11. The coordinate measuring machine according to claim 9, comprising a crash-protection functionality, wherein the crash-protection functionality is configured to provide an assessment regarding a collision of at least one member with an object in the environment based on the spatial arrangement data and the predicted pose of the at least one member, in particular wherein the coordinate measuring machine comprises a brake configured to hinder, or to lock, the movement of at least one braked member based on the assessment regarding a collision of at least one member.

12. The coordinate measuring machine according to claim 1, wherein:
the coordinate measuring machine comprises at least one motorized member and a servo-functionality
the motorized member is configured to provide a servo-torque, and
the servo-functionality is configured to set the servo-torque with respect of the actual and predicted pose of the monitored member.

13. The coordinate measuring machine according to claim 1, wherein:
the set of sensors comprises a temperature sensor,
the at least one state variable is a temperature of at least one member and/or a temperature of the probe, and
the support action comprises a suggestion for an amended grip by the operator.

14. The coordinate measuring machine according to claim 1, wherein:
the coordinate measuring machine is configured to access an operator database,
the operator database comprises an operator identifier and data regarding a history of operator behavior,
the coordinate measuring machine is configured to associate a current operator with one of the operator identifiers, in particular automatically based on a comparison of current operator behavior with the history of operator behavior, and
the accuracy-perception-data is provided further on the basis of current operator behavior and of the history of operator behavior.

15. The coordinate measuring machine according to claim 14 being configured:
to record the current operator behavior,
to adapt the history of operator behavior based on the recorded current operator behavior.

16. The coordinate measuring machine according to claim 15 being configured to provide an assessment regarding an evolution of the operator behavior.
